(19) United States
(12) Patent Application Publication
(10) Pub. No.: US 2025/0161724 A1
(43) Pub. Date: May 22, 2025

(54) FACE COVERING SYSTEMS AND METHODS OF MAKING SAME

(71) Applicant: BREEZLYTE LLC, Fremont, CA (US)

(72) Inventors: David B. KITA, Fremont, CA (US); Douglas PAHEL, Hayward, CA (US); Dale E. CHRISTMAN, Rio Vista, CA (US); Baran TOPRAK, Voluntari (RO)

(73) Assignee: BREEZLYTE LLC, Fremont, CA (US)

(21) Appl. No.: 18/674,124

(22) Filed: May 24, 2024

Related U.S. Application Data
(60) Provisional application No. 63/504,104, filed on May 24, 2023.

(51) Int. Cl. A62B 23/02; A62B 9/06; A62B 18/08

(52) U.S. Cl. CPC A62B 23/025; A62B 9/06; A62B 18/084

(57) ABSTRACT

Face covering system for protecting a wearer from airborne particulate matter includes a headband attachment system and a face covering having a plurality of layers, as follows: an outer, a stiffening, a filtration, and an inner layer. The face covering forms a breathing space in the unfolded or donning position. The breathing space is formed by an upper nose panel, a bottom chin panel, a top central panel, and a bottom central panel. The upper nose and bottom chin panels are conformable to the face while cooperating with the top and bottom central panels. The breathing space provides for improved comfort and sealability and operates to help keep the upper nose and bottom chin panels from rubbing against the wearer's lips. The face covering system further includes a nose cushion member, a nose wire, and various welds and weld seams for coupling the various components of the face covering together.

### CROSS-REFERENCE TO RELATED APPLICATIONS

This application claims priority from U.S. Provisional Application No. 63/504,104, filed on May 24, 2023, the subject matter of which is incorporated herein by reference in its entirety.

### FIELD OF THE INVENTION

This invention generally relates to face covering systems, and more specifically to face covering systems having various layers, panels, welds, and weld seams that permit the face covering system to provide a comfortable breathing space and meet a desired level of filtration efficiency.

### BACKGROUND

The present invention generally relates to the field of portable, lightweight protective face covering systems, commonly referred to as respirators (broadly interpreted), face masks, or face coverings in common parlance, and technically referred to as Filtering Facepiece Respirators (FFRs). The protective face coverings operate to minimize the amount of exhaled particulate cast into the ambient environment from the wearer and to filter the inhaled air to minimize the amount and/or type any infectious, toxic, or other unwanted airborne particulate matter that may otherwise be capable of making its way into the respiratory system of the wearer. By way of example, during the COVID-19 pandemic, standard surgical masks 14 (FIG. 1) became a cost-effective apparel necessity for many people trying to mitigate the possibility of catching and/or transferring the COVID-19 virus.

Albeit the standards and terminology in the FFR space can be confusing, and they vary from country to country (e.g., N95, KN95, ASTM F2100, FFP1, FFP2, P2, or surgical N95), so FIG. 1 shows a chart 10 displaying several types of face coverings and some of the most well-known testing standards as they relate to each type of face covering. In the United States (U.S.), the Centers for Disease Control (CDC) recommends that people should wear the most protective face covering possible if it is properly rated or certified for the environment, it can be worn comfortably and regularly, and it fits well on the wearer to provide a desired or required combination of breathability, filtration, sealability, and comfort. Occupational grade 16 respirators give the most protection and least comfort, surgical mask 14 typically provide the next most protection with more comfort and breathability but with reduced sealability and filtration, and single-use masks provide the least amount of protection with the most comfort, making them convenient and yet typically inappropriate for occupational or healthcare-related applications.

In the U.S., for example, the National Institute for Occupational Safety and Health (NIOSH) tests and approves respirators that are used in occupational settings. The most well-known NIOSH-approved respirators are FFRs. FFRs are designed to cover areas of the wearer's face from the bridge of the nose to the chin. They often achieve high filtration efficiency via incorporating either a fine weave of electrostatically charged synthetic filter fibers, or alternatively nanofiber materials, which rely on various diffusion processes, (either would be referred to commonly as “filtration media”) and elastic headband straps. FFRs are worn on the wearer's face, over the nose and mouth, to filter particulate matter (e.g., dust, pollen, pollutants, oil droplets) or other particles, such as, but not limited to, bacterial or viral particles, suspended in the air, in the form of aerosols, as ambient air is inhaled. There are nine filter classes for FFRs. The classes are made up of three levels of filtration efficiency (95%, 99%, and 99.97%), and three series of protection against oil aerosols: (1) Not resistant to oil (N-type); (2) Resistant to oil (R-type); and (3) oil Proof (P-type). These filtration efficiencies correspond to the percentage of the challenge aerosol collected by the FFR's filter media during testing. For example, an FFR marked N95 would indicate an N-series filter that is at least 95% efficient.

All NIOSH-approved FFRs must pass a standardized test to verify that tiny particles like dust, dirt, viruses, and bacteria will be captured by the respirator's fibrous filtration media when worn. NIOSH N-series tests simulate the ability of a challenge aerosol composed of NaCl cubic crystals to penetrate the FFR. Alternatively, FFP2 respirators certified according to the EN 149:2001 standard, which is used for FFRs throughout Europe, also additionally require resistance to oil penetration as per tests simulating the ability of a challenge aerosol of paraffin oil droplets to penetrate the FFR.

By way of example, a NIOSH-approved N95 FFR provides a conservative measure of filtration efficiency that ensures the filtration media will capture at least 95% of non-oil aerosols when inhaled through the face covering. See, “Understanding Filtration Efficiency Testing and Fit Testing in Filtering Facepiece Respirators (FFRSs),” DHHS (NIOSH) Publication No. 2021-123 (November 2021), https://doi.org/10.26616/NIOSIHPUB2021123revised112021.

For purposes of clarity, the single-use masks shown in FIG. 1 are normally made from a single, thin layer of material (“Single-Use Face Mask” 12) typically only effective at capturing larger dust particles. The surgical mask 14 has higher requirements for capturing virus-sized (0.1 micron) particles and bacteria-sized (3.0 micron) particles, however the filtration requirements vary by region. Most surgical masks are held on the wearer's head and face via the use of ear loops and a nose wire. As a result, surgical masks are notorious for not sealing well to the wearer's face and thus protection from the external environment can be adversely affected. On the other hand, surgical masks 14 may largely block particles ejected from the mouth or nose of the wearer when the wearer speaks, coughs or sneezes, therefore affording protection for others from possible contaminants, biological or otherwise, from the wearer. Most standards also require that surgical masks 14 be resistant to penetration by blood during medical procedures. Other types of respirators (i.e., high filtration efficiency) 16 that are typically used by healthcare professionals or essential workers may be able to capture more than ninety percent (≥94-95%) of virus-sized particles, depending on the country. Note that particulate matter size requirements for N95 and KN95 respirators is 0.3 microns, because typically those sizes are the hardest size range to capture and intercept via filtration media. Almost virtually all occupation grade 16 respirators are held on the wearer's head and face via headbands, as required by each country's regulatory standard, in concert with both a nose wire and a nose cushion member (typically nose foam). Each country has their own certification standard for each face covering type. For example, Europe uses the EN 14683 standard for surgical mask 14, whereas China uses the YY 0469 standard. Each standard varies a little by country, however they are broadly similar. For respirator masks 16, China uses the KN standard (e.g., KN95) and the U.S. uses the N standard (e.g., N95), while Europe uses EN 149:2001. Surgical N95 respirators adhere to both the requirements of N95 respirators in the U.S., but also the ASTM F2100 standard for surgical masks.

### BRIEF SUMMARY OF THE INVENTION

The present invention generally relates to a face covering system having a head attachment system and a face covering that includes a plurality of layers (an outer layer, a filtration layer, and an inner layer). The face covering further includes a breathing space when in the unfolded or donning position. The breathing space is enclosed by an upper nose panel to generally cover the nose area of a wearer's face, a bottom chin panel to generally cover the chin area of the face, a top central panel to cover the upper mouth portion of the face, and a bottom central panel to cover the lower mouth portion of the face. The upper nose and bottom chin panels are moveable and conformable to the face while cooperating with the top and bottom central panels. The top and bottom central panels are sufficiently flexible for cooperating with the upper nose and bottom chin panels to provide the breathing space. The face covering further includes a nose cushion member, a nose wire, and at least two headband welds. The nose cushion member is made from a foam material, and it is located on the inner layer adjacent to the nose wire. The nose cushion member is exposed to the ambient air when the face covering is unfolded. The nose wire is located between two of the plurality of layers of the face covering. The two headband welds attach the head attachment system to the face covering.

In another aspect of the present invention, the face covering system includes a head attachment system and a face covering having a plurality of layers (an outer layer, a stiffening layer, a filtration layer, and an inner layer). The face covering includes a plurality of panels that form a breathing space when in the unfolded or donning position. The plurality of panels takes the form of an upper nose panel, a bottom chin panel, a top central panel, and a bottom central panel. The face further includes a nose cushion member, a nose wire, and at least two headband welds. The nose cushion member is located on the inner layer adjacent to the nose wire. The nose wire is located between two of the plurality of layers of the face covering. The two headband welds secure an upper and a lower headband of the headband attachment system to the face covering. The face covering further includes an equatorial weld seam that terminates at the right and left sides of the face covering. The equatorial weld seam extends latitudinally and structurally couples the top and bottom central panels of the face covering system by fusing the plurality of layers comprising the top and bottom panels.

In yet another aspect of the present invention, the face covering system includes a head attachment system and a face covering that includes a plurality of layers (an outer layer, a filtration layer, and an inner layer). The face covering further includes an upper nose panel to generally cover the nose area of a wearer's face, a bottom chin panel to generally cover the chin area of the face, a top central panel to cover the upper mouth portion of the face, and a bottom central panel to cover the lower mouth portion of the face. The number of each of the layers are arranged and configured such that the filtration efficiency of the face covering system does not decrease by more than two percent (2.0%) from its unsaturated state to its saturated state. The nose member is located on the inner layer adjacent to the nose wire. The face further includes a nose cushion member, a nose wire, and at least two headband welds. The nose wire is located between two of the plurality of layers of the face covering. The two headband welds secure an upper and a lower headband of the headband attachment system to the face covering.

In still yet another aspect of the present invention, the face covering system includes a head attachment system and a face covering that includes a plurality of layers (an outer layer, a filtration layer, and an inner layer). The face covering further provides a breathing space when in the unfolded or donning position. The breathing space is enclosed by an upper nose panel to generally cover the nose area of a wearer's face, a bottom chin panel to generally cover the chin area of the face, a top central panel to cover the upper mouth portion of the face, and a bottom central panel to cover the lower mouth portion of the face. The face covering further includes a nose cushion member, a nose wire, and at least two headband welds. The nose cushion member is located on the inner layer adjacent to the nose wire. The nose wire is located between two of the plurality of layers of the face covering. The two headband welds secure an upper and a lower headband of the headband attachment system to the face covering. The breathing space enclosed by the four panels provides comfort, sealability, and operates to help keep the upper nose and bottom chin panels from rubbing against the lips of the wearer when the wearer is communicating, breathing, or doing other tasks that may cause movement of the lips of the wearer.

### BRIEF DESCRIPTION OF THE DRAWINGS

The drawings illustrate only example embodiments, and therefore do not limit the scope of the present invention, as other equally effective embodiments are within the scope and spirit of this disclosure. The elements and features shown in the drawings are not necessarily drawn to scale, emphasis instead being placed upon clearly and legibly illustrating the principles of the present invention. Additionally, or alternatively, certain dimensions or features may be exaggerated or shown in a see-through format to help visually convey certain principles, functions or relative locations. In the drawings, similar reference numerals between figures designate like or corresponding, but not necessarily the same, elements. A more complete appreciation of the present invention will become more readily apparent as the invention becomes better understood by reference to the following detailed description when considered in conjunction with the accompanying drawings. The drawings include the following figures.

FIG. 1 shows a chart of prior-art face coverings with images of a single-use face mask, a surgical mask, and a respirator mask.

FIG. 2 shows a front, upper, right, perspective view of a face covering system having a four (4)-panel face covering with attached headbands, in an unfolded or open configuration, such as when the face covering system is donned or worn, according to an embodiment of the present invention.

FIG. 3A shows an exploded side view taken from FIG. 5A of some of the face covering components according to an embodiment of the present invention.

FIG. 3B shows an exploded side view taken from FIG. 5A of some of the face covering components according to an embodiment of the present invention.

FIG. 3C shows an exploded view of multiple filtration layers, in conjunction with an outer, inner, and stiffening layer, according to an embodiment of the present invention.

FIG. 4 shows a table listing at least some of the components of the face covering along with the type of component material and one or more physical or operational properties of the component materials according to an embodiment of the present invention.

FIG. 5 is a front view of the face covering of FIG. 2 in an unfolded or open configuration that shows the headband welds, the four (4) panels, and various welded seams, that act in concert to form a sufficiently sized and comfortable breathing space for the wearer according to an embodiment of the present invention.

FIG. 5A shows a cross-sectional view of the face covering in FIG. 5 in an unfolded or open configuration taken along line 5A-5A according to an embodiment of the present invention.

FIG. 5B shows a cross-sectional view of the upper and lower headband welds taken along line 5B-5B of FIG. 5 according to an embodiment of the present invention.

FIG. 6 shows a left, forward-looking perspective view of the face covering system of FIG. 2 in an unfolded or open configuration showing the interior of the face covering and the breathing space enclosed by the four (4) distinct panels according to an embodiment of the present invention.

FIG. 7 shows the face covering system in a folded or closed configuration according to an embodiment of the present invention.

FIG. 8 shows a face covering system with a face covering having a valve-type device incorporated into the face covering system according to another embodiment of the present invention.

### DETAILED DESCRIPTION

For purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail to avoid obscuring the present invention. As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure, or characteristic described in connection with the given example may be included in at least one embodiment of the present invention. Features, structures or characteristics may be combined in any suitable combinations and/or sub-combinations in one or more embodiments or examples.

In the following description, certain specific details are set forth to provide a thorough understanding of various embodiments of the invention. Unless the context requires otherwise, throughout the specification and claims which follow, the word “comprise” and variations thereof, such as, “comprises” and “comprising” are to be construed in an open, inclusive sense, which is as “including, but not limited to.” The headings provided herein are for convenience only and do not interpret the scope or meaning of the claimed invention.

In accordance with the purpose(s) of the present disclosure, as embodied and broadly described herein, embodiments of the present disclosure, generally relate to face covering systems, and more specifically face covering systems that are light, portable, and provide an improved level of comfort, breathability, sealability, and filtration as compared to other state of the art face covering systems such as, but not limited to, standard surgical masks 14 commonly worn by many people during the COVID-19 pandemic or other respirators 16 used by healthcare professionals or essential workers during the pandemic. The face covering of the present invention includes four (4) panels configured to create a ‘breathing space’ for the wearer. The face covering also includes various layers that are arranged to achieve desired levels of sealability, filtration, whether for particulate matter, aerosols, bacteria, or viral particles, and breathability, wherein the desired levels may meet or surpass one or more regulations, rules, or laws, such as, but not limited to, those for NIOSH N/R/P 95/99, FFP I/II/II, KN95, KF94, ASTM F2100, EN14683 or surgical N95 respirators. Additionally or optionally, the various layers may be selected to provide the present face covering system with unique aspects when viewed in comparison with other state-of-the art face covering systems. In addition, the face covering system of the present invention includes a highly flexible headband attachment system coupled to the face covering through headband welds formed by an ultrasonic weld process. The face covering system of the present invention also includes a nose cushion member and a nose wire to improve comfort and sealability around the wearer's nose.

For purposes of brevity and clarity, the following terms and variations thereof such as, but not limited to, “respirator,” “mask,” “covering,” and other similar terms as used herein should be broadly interpreted and may be used interchangeably. For purposes of the present invention, the term “respirator” as used herein typically refers to a device having a certifiable filtration efficiency of 95% or higher (see Paragraph 0003 in the Background section above). Likewise, the term “mask” as used herein typically refers to a device typically having a filtration efficiency that is substantially lower than 95%. And the term “covering” (or “face covering”) is used to primarily describe the present invention, and in at least some embodiments of the present invention the “covering” has a filtration efficiency of 95% or higher. While the Applicant has tried to use the terminology adopted by the CDC, NIOSH, and other regulatory bodies, Applicant reserves the right to be its own lexicographer and refer to any component by a name or label even if it somewhat differs than the terminology used by the regulatory agencies or other entities.

The term “breathability” generally means that a component may be suitable or pleasant for breathing, that a component permits air to pass through, or both (See, American Heritage® Dictionary, 5th Edition, © 2016 by Houghton Mifflin Harcourt Publishing Company). The converse terms of “breathing resistance” and “inhalation/exhalation resistance” all refer to the degree of resistance of ambient air flow into and out of the respiratory tract of die wearer during inhalation and exhalation, respectively. Thus, a face covering with a high degree of breathability, as defined herein, also has a low degree of breathing resistance.

The term “sealability” merely refers to the ability of the face covering to adequately seal against a wearer's skin to prevent penetration of particulate matter, including bacterial or viral particles, via leaks or openings at the boundaries of the mask or respirator, and may be used synonymously with terms like airtight, leakproof, airtight, and others.

The term “filtration efficiency” of a respirator, mask, or covering is generally measured under strict conditions in relation to a defined test particulate (e.g., dust, NaCl aerosol, paraffin oil droplets, etc.). As a brief caveat, the number and type classification systems, test procedures, and the particulate matter used for testing, have evolved in various countries, but the underlying objective is to measure the type (i.e., size) and amount of the particulate matter that may penetrate into or through the respirator, mask, or covering. Particle filtration efficiency (PFE), bacteria filtration efficiency (BFE) and viral filtration efficiency (VFE) (hereinafter referred to as just “filtration efficiency”) are tests that are commonly done to evaluate respirators, masks, coverings, and other components of the same that may perform a filtration function.

By way of example, the PFE test may be done in accordance with ASTM F2299-03, which uses aerosolized latex particles, usually 0.1 micron, as the challenge aerosol. Control counts are performed without a test sample in the system, then the sample is tested. Filtration efficiency is determined by comparing the counts through the sample to the control counts. By way of another example, the PFE test may also be done in accordance with NIOSH 42 CFR 84 subpart K using NIOSH Procedure No. TEB-APR-STP-0059, which uses aerosolized NaC cubic crystal particles, with a particle size distribution with count median diameter of 0.075 (±0.020 μm (microns)), as the challenge aerosol. In one variant, the NIOSH NaCl PFE test is performed over a length of time that allows the respirator, mask, or covering to become saturated with deposited NaCl, a so-called ‘loading test’, to ensure the maximum observed penetration does not exceed a predetermined threshold, but that observed temporal behavior is deemed acceptable in accordance with the NIOSH standard. In another variant of the PFE test, the NIOSH NaCl PFE test is performed as a short duration test, with a single data point, wherein the respirator, mask, or covering is not saturated with NaCl aerosol (i.e., the “unsaturated” state during the NaCl PFE test), to assess the penetration of the challenge aerosol, the breathing resistance at the tested air flow rate, or both.

In another example, the BFE test may be done in accordance with ASTM F2101-01, which uses an aerosol of Staphylococcus aureus (S. aureus) to evaluate the BFE of face-mask materials. Other types of bacterial organisms may be used; however they may give different results because of differences in shape and size. S. aureus has an approximate diameter of 0.8 microns. The organisms are generated into an aerosol with a nebulizer. As in the PFE test, the control is determined from counts without the test specimen in the system.

The VFE test procedure is a test adapted from the Military Standard MIL-M-36954C and ASTM F2101 specifications. The challenge aerosol is Bacteriophage OX174. The bacteriophage is one of the smallest viral organisms. The challenge aerosol has a diameter in the range of about 0.025-0.027 microns. The testing is very similar to the BFE test, except a smaller organism is used.

The terms “elongation capacity” and “stretchability” are used herein synonymously. Technically speaking, the elongation capacity of a material is measured by applying a tensile force or by “stretching” (i.e., stretchability) the material while determining the change in length from its original or starting length. Elongation capacity is expressed as a percentage of the original length, where elongation capacity=ΔL/L×100%, where L is the original length, and ΔL is the change in length (i.e., “elongation) for a particular amount of applied tensile force. The non-technical term “stretchability” may be used in some places herein whenever it seems appropriate to refer to the stretching capability of a component and to provide clarity for non-technical audiences unfamiliar with the term “elongation.”

The term “meltblown” refers to a conventional fabrication method of microfibers, nanofibers, or both where a polymer melt is extruded through small nozzles surrounded by high-speed blowing gas. The randomly deposited fibers form a non-woven sheet is ideal for filtration, sorbents, apparels, and PPF products such as face masks and respirators. Meltblown materials or components are often used as the filtration layer in the middle of a face covering or respirator, which in turn allows the face covering or respirator to possibly filter bacteria and viruses in the sub-micron range.

The term “spunbond” also refers to a fabrication method in which materials or components are produced by depositing extruded, spun filaments onto a collecting belt in a uniform random manner by bonding the fibers. The fibers are separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used as thermal binding fibers. Polyethylene or random ethylene-propylene copolymers are used as low melting bonding sites.

The term “nonwoven” may refer to a type of material or a fabrication process. Nonwoven components are typically made from polyester, polypropylene, nylon, spandex, acrylic, and other similar materials, whereas the spunbond method usually refers to only polyester and polypropylene spunbond components. Depending on the application, usually either fabrication process may produce a suitable, but similar end-product. There are many production processes for the manufacture of non-woven materials, among which the spunbond method is one of the non-woven fabric production processes while other processes may include, but are not limited to, a spunbond method, a melt spray method, a hot rolling method, and a spunlace method. When nonwoven is used to refer to a type of material, such a nonwoven material, in most situations, is made from polymer slices, short fibers or filaments that are combined to make fibers through air pressure or mechanical means to intermix the slices, fibers, or filaments. Beneficially, a nonwoven component may be soft, breathable and have a planar structure that is strong, durable and silky. Depending on the manufacturing process, nonwoven components may have a cottony feel as compared with actual cotton fabrics, and nonwoven components are relatively easy and cost effective to produce.

The term “polyester staple fiber” as generally used herein refers to a synthetic (i.e., man-made) fiber of purified terephthalic acid (PTA) and monoethylene glycol (MEG). However, the polyester staple fiber may also be made out of different materials that are different but still similar enough to PTA and MEG. Depending on the exact manufacturing process and possibly other factors, the polyester staple fiber may also be biodegradable and recyclable.

The term “breathing space” as generally used herein refers to a volume that is external to the wearer's face but covered by the face covering system of the present invention such that the wearer's mouth, lips, nostrils, and the areas in between, do not typically come in contact with components of the face covering system during various facial or head movements such as, but not limited to, breathing, talking, sleeping, smiling, frowning, and various mannerisms or gestures like looking up, looking down, turning one's head to the side, and nodding. In contrast, surgical masks 14 typically have little to no breathing space, and the material of the mask often comes in contact with the wearer's mouth, nostrils, or both during typical facial or head movements and other mannerisms or gestures. By way of example, the occupational grade respirators 16 may have different breathing spaces based on their morphology and shape. For some specific examples, the cup-style respirators have one type of breathing space, while duck-billed respirators have another, and fish-style respirators have yet another differently shaped breathing space.

It is therefore at least one object of the present invention to provide a face covering system that attempts to provide a comfortable, form-fitting, face covering while bridging the gap between the highly effective, high filtration efficiency, well sealing, higher breathing resistance, occupational grade respirators 16 (with headbands) that were used during the COVID-19 pandemic by medical personnel and healthcare workers, and the lower breathing resistance, lower filtration efficiency, poorly sealing, more portable, inexpensive, more convenient surgical masks 14 (with ear loops) that became popular with US consumers during the COVID-19 pandemic. By way of example, the face covering system of the present invention is form fitting and seals well to the wearer's facial features and skin across many adult facial types with different face/head dimensions due to its four (4)-panel configuration, while simultaneously providing for a comfortable breathing space.

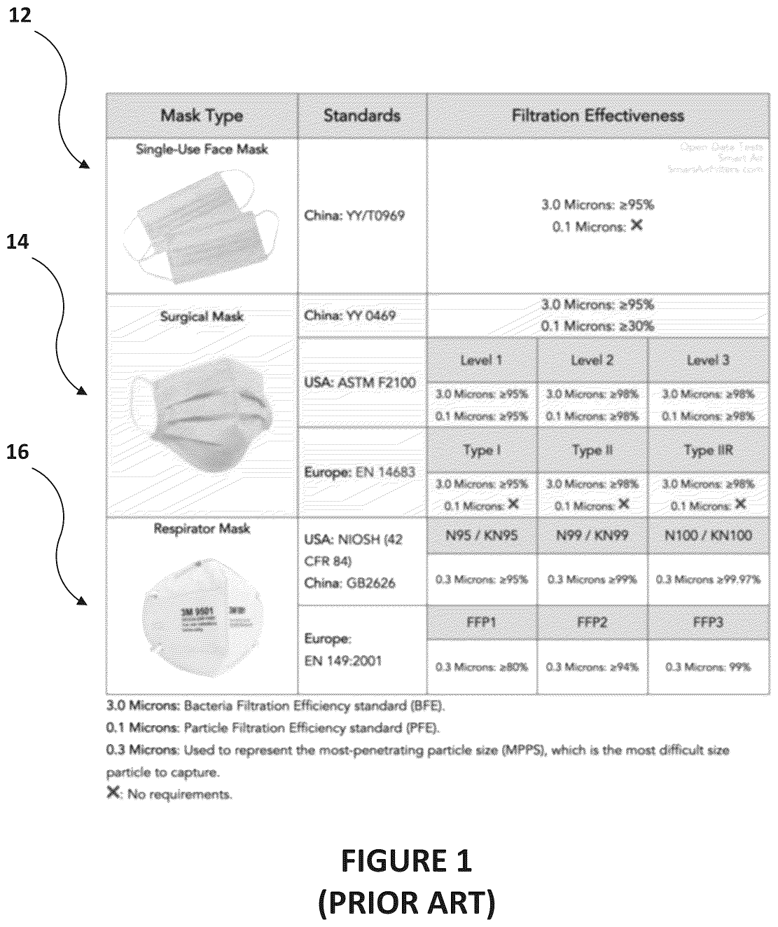

Additionally, or alternatively, the face covering system includes a multi-layer arrangement (e.g., outer layer, inner layer, filtration layer, and stiffening layer) that attempts to strike a desired balance between breathability, sealability, filtration efficiency, and comfort while being cost effective to manufacture, lightweight, and portable like the surgical mask 14. With respect to sealability, the surgical mask 14 shown in FIG. 1 generally does not seal well to most faces, often failing to seal at side edges that tend to bow outward, thus creating an air space, gap, or opening adjacent to the cheeks of the wearer when donned, especially when the wearer is communicating or moving their mouth in some manner. Moreover, surgical masks 14 often touch or contact the wearer's mouth or lips, leaving little space for breathing, talking, or various facial expressions. The face covering system of the present invention overcomes this drawback, among others as discussed elsewhere herein, while providing high filtration efficiency with concurrent high breathability (i.e., low breathing resistance) and high sealability across a variety of adult facial types and face/head dimensions, without sacrificing comfort, portability or convenience.

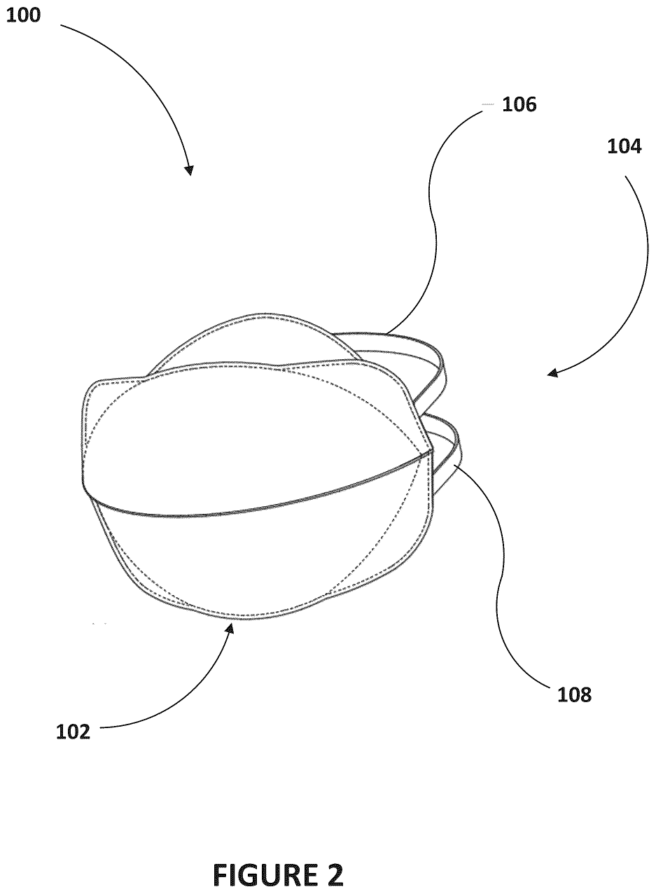

FIG. 2 shows a face covering system 100 having a face covering 102 and a head attachment system 104 having an upper elastic headband 106 and a lower elastic headband 108 according to an embodiment of the present invention. By way of example, the face covering system 100 may be sold under the mark BREEZLYTE™, BREEZLYTE AIR 2020™, or just AIR 2020™. In the illustrated embodiment, the face covering system 100 is shown from the front in an unfolded or donned position, which means the mask is oriented as if it were being worn or about to be worn. In one embodiment, all of the materials for the various components of the face covering system 100 are made from some sort of plastic or polymeric material. In other embodiments, one or more components of the face covering system 100 may be produced with a film or other coating to be resistant to penetration by oil (e.g., a hydrophilic coating), water (e.g., a hydrophobic coating), blood, some combination thereof, or the film or coating may provide resistance to the penetration of other particulates of matter depending on the type of coating or film that is used. In other embodiments, one or more components of the face covering system 100 are made from a non-plastic or non-polymeric material. In yet another embodiment, one or more components of the face covering system are made from biodegradable and/or recyclable materials.

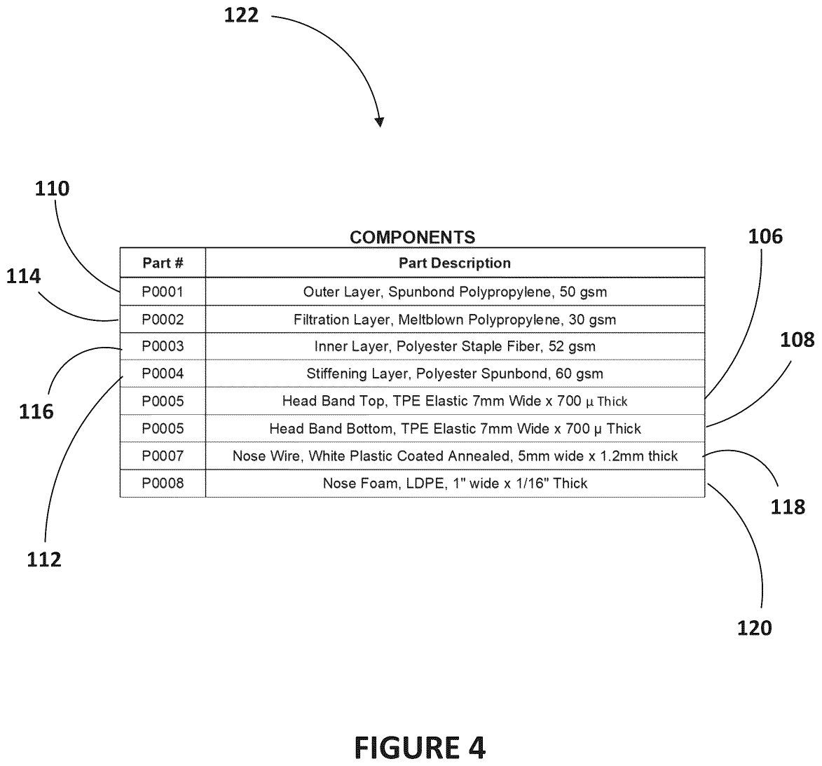

In one embodiment, the elastic headbands 106, 108 are both made from a thermoplastic elastomer (TPE) material with the same length, width, and thickness, or optionally, the headbands 106, 108 may be made from different materials with different lengths, widths, or thicknesses to achieve different levels of stretchability or elongation capacity for each of the headbands 106, 108 depending on desired design considerations. For purposes of clarity, one of Applicant's preferred embodiments includes the headbands being elastic, thus the headbands may be referred to herein as ‘elastic headbands,’ but it should be understood and appreciated that the headbands may be made from a non-elastic material. By way of example, the upper elastic headband 106 may be longer, narrower, thinner, and thus have a higher degree of stretchability as compared to the lower elastic headband 108. Table 122 of FIG. 4 shows one embodiment of the various materials and other physical properties of the face covering system 100 components such as, but not limited to, the headbands.

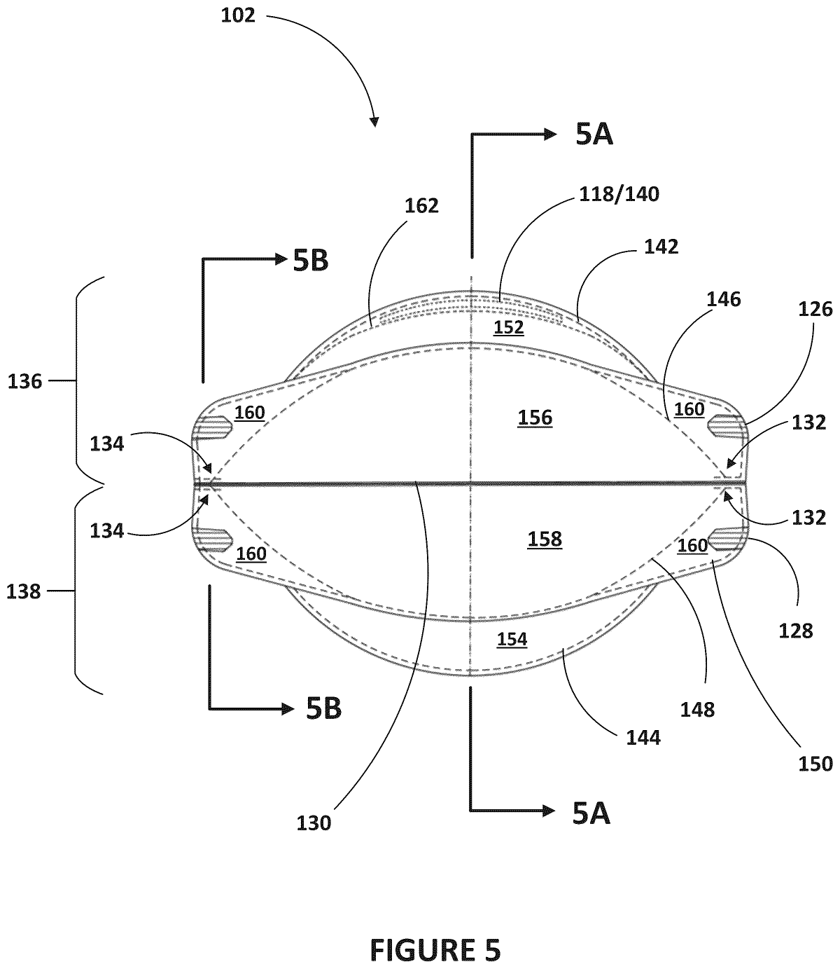

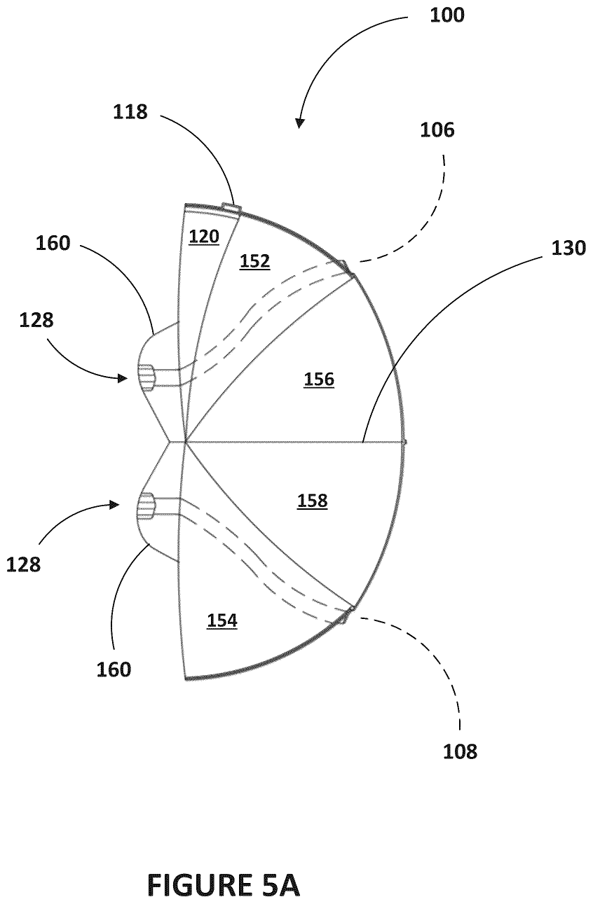

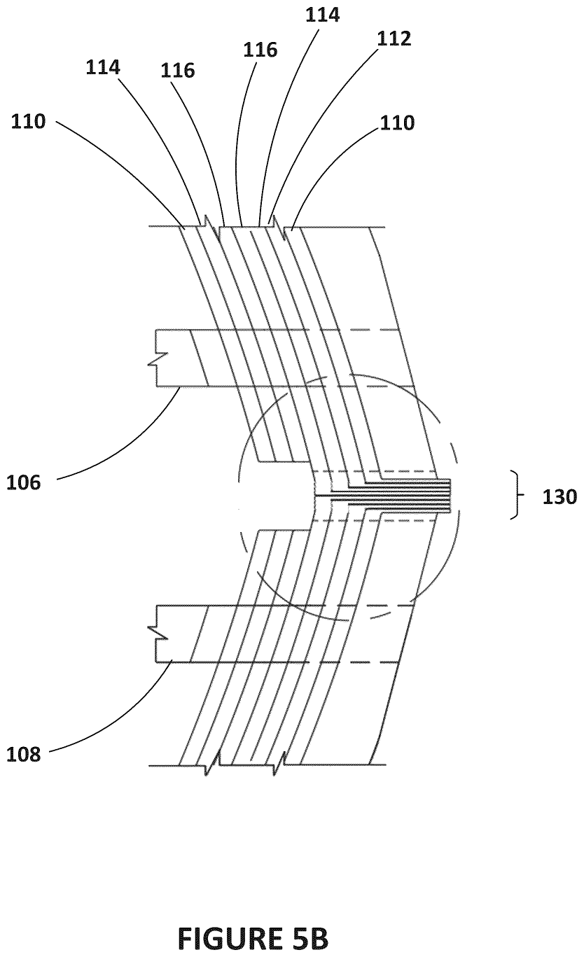

In at least one embodiment of the present invention, both the upper and lower elastic headbands 106, 108 have an elongation capacity of about three hundred percent (300%). In the preferred embodiment of the present invention both the upper and lower elastic headbands 106, 108 have an elongation capacity that exceeds or equals four hundred and fifty percent (450%) or greater. This means the upper and lower elastic bands 106, 108 have a high degree of stretchability such that it can be donned and worn on a vast array of head sizes. The combination of the headband properties (dimensions, material, density, etc.) with the configuration of the headband welds 126, 128 (described below with reference to FIGS. 5-7) on both sides of face covering 102 may advantageously benefit the wearer because the amount of pressure applied by the upper and lower headbands 106, 108 to the face covering 102, and hence on the wearer's head and face may be less, and even substantially less, than the pressure exerted by other respirator masks 16. In at least one embodiment, the elastic headbands 106, 108 exert a low pressure (Force/Area) on the wearer's head and face via their pull on face covering 102 when headbands 106, 108 are elongated during donning and wearing of face covering 102, thus the headbands 106, 108 have an extremely good ratio of elongation to exerted head/face pressure (e.g., a high ratio means the headband is highly stretchable while exerting a low amount of contact pressure to the head/face of the wearer via their pull on face covering 102), especially when compared to other high filtration efficiency face covering systems that are currently known in the respiratory system arts. Similarly, in at least one embodiment, the elastic headbands 106, 108 exert a low pressure (Force/Area) on the wearer's head or neck where the headbands make direct contact with the wearer's head (and ears), upper headband 106, and wearer's neck and jaw, lower headband 108, when headbands 106, 108 are elongated during donning and wearing of face covering 102.

The combination of features such as, but not limited to, at least one embodiment of high elongation capacity headbands, the four (4)-panel configuration forming the resultant breathing space, and the various welds and headband welds that bring the components together while providing structural integrity, provides for a more comfortable face covering system, with less exerted force or pressure on the face and head, that may be worn longer without a similar level of discomfort or irritation when compared to other higher filtration efficiency face coverings 16, while capable of maintaining a high quality seal across a wide range of adult facial types, head shapes, and face/head dimensions. Nevertheless, it is appreciated that more than one size of the face covering system 100 may be produced to adequately handle the large variation of head shapes, facial types, and face/head dimensions of the wearers among the general population, including the smaller head sizes and different facial shapes of children under the age of eighteen (18) years old. By way of example, the following chart depicts the NIOSH NPPTL bivariate panel used in the ASTM F3407—Fit Test to assess the seal-fit capabilities of a face covering or respirator across a sample of adult faces from the general population with different face lengths (i.e. menton-sellion length) and face widths (i.e. bizygomatic breadth), wherein numbers No. 1 through No. 10 refer to different facial types or categories, with No. 1 being representative of faces that are both short and narrow, and No. 10 being representative of faces that are both long and wide. In the following chart the numbers in parentheses refer to relative frequencies during seal-fit testing, with categories No. 4 and No. 7, both in the middle of facial length and facial width, being the most commonly occurring.

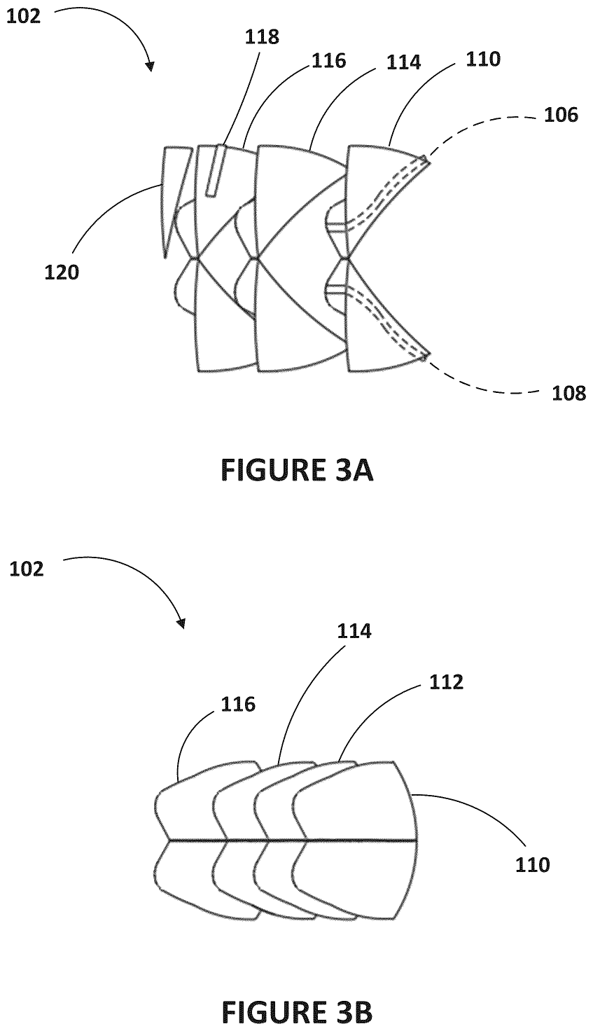

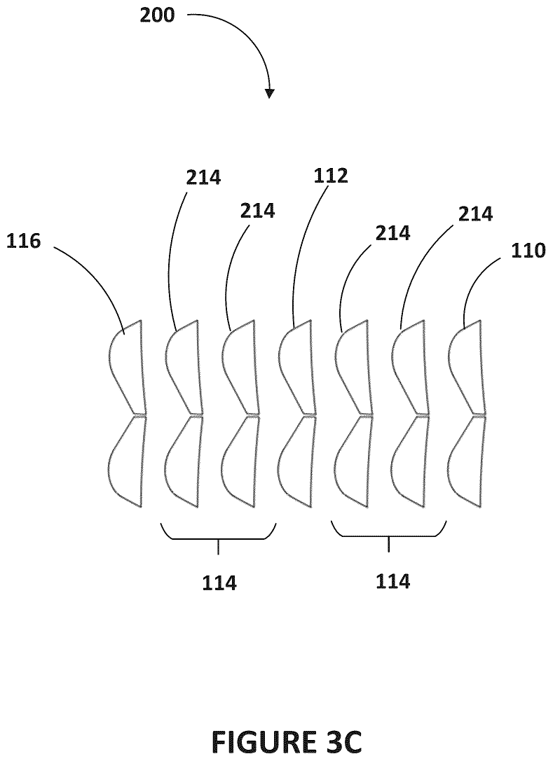

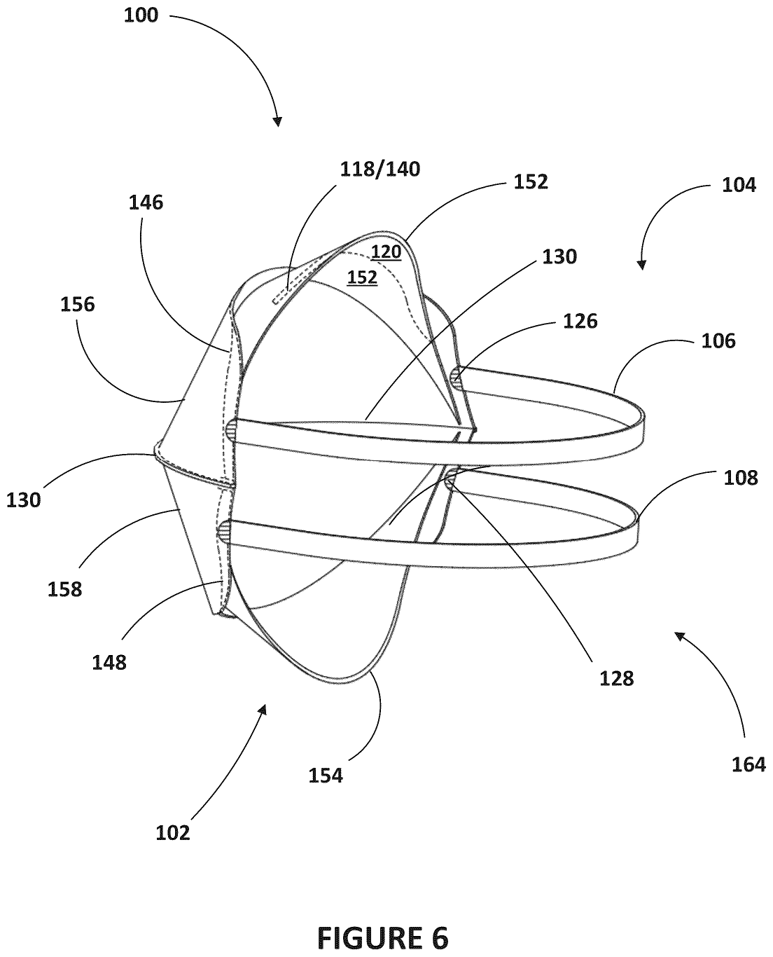

FIGS. 3A and 3B show a partially exploded side view of the face covering 102 having an outer layer 110, a stiffening layer 112, a filtration layer 114, and inner layer 116. For purposes of clarity, the term “layer” is used distinctly from the term “panel” herein. The layers are the sheets of material (e.g., each sheet of material may also include multiple plies), that are abutted or placed against other layers (e.g., the outer layer 110 abuts the stiffening layer 112, which abuts the filtration layer 114, etc. (see FIG. 3B). In contrast, the panels 152, 154, 156, and 158 (FIGS. 5A, 6) may include one or more layers, but the union of panels 152, 154, 156, and 158 and the associated welds refer to the four (4)-panel unfolded configuration that is described in detail below with respect to FIGS. 2, 5A, and 6.

In one embodiment of the present invention, the outer layer 110 is made from one sheet of a spunbond or nonwoven polypropylene material having about a fifty (50) gsm weight, the inner layer 116 is made from one sheet of a polyester staple fiber having about a fifty-two (52) gsm weight, the stiffening layer 112, which will be described in more detail below, is made from one sheet of polyester spunbond or nonwoven material having about a sixty (60) gsm weight, and the filtration layer 114, which will also be described in more detail below, is made from one sheet of a meltblown polypropylene material having about a thirty (30) gsm weight.

Referring briefly again to FIG. 4, Table 122 shows one embodiment of the various materials and other physical properties of the face covering system 100 components such as, but not limited to, the materials and other physical properties of the various layers, 110, 112, 114, and 116, respectively. While Table 122 shows specific materials and physical properties for the various components, it is understood and appreciated by those skilled in the art that each component may be made from a different material, multiple materials, and have different physical properties as compared to those listed in Table 122 of FIG. 4, including, but not limited to, different surface densities (gsm), different dimensions, including different thicknesses and different widths, spanning some or all or a portion of the four (4) panels, 152, 154, 156, and 158 (FIGS. 5A, 6). The selection of different materials may result in different filtration efficiencies, respectively, for particulate matter, aerosols, bacterial particles, and viral particles, and have different physical properties, including, but not limited, (low) flammability, resistance to (synthetic) blood penetration, resistance to (paraffin) oil, reduced skin irritation, high sealability, and low breathing resistance. Also the relative ordering of the layers with respect to each other may provide additional advantages and benefits for specific or unique applications or environments. Also, the relative positioning of the layers and the four (4) panels with respect to each other and with respect to the other components may provide additional advantages and benefits for specific or unique applications or environments.

Referring back to FIGS. 3A and 3B about the various layers, and specifically the filtration layer 114, each layer typically comprises a standard sheet or ply of its respective material. In one embodiment, the layers may be conceptually viewed as plies or ply layups like how plies of fiber reinforced resin composite structures are laid up relative to each other to produce different structural strengths and other properties. By way of example and in accordance with one embodiment of the present invention as shown in FIG. 3C, the filtration layer 114 may be made from multiple plies of meltblown polypropylene and the plies may be oriented with respect to each other to achieve a desired level of filtration efficiency in which the filtration layer 114 captures at least ninety-five percent (95%) of the non-aerosol particulates that may be inhaled through the face covering system.

In yet another and slightly different embodiment, the filtration layer 114 may be a combination of more than one filtration layers or stated otherwise, the face covering 102 may include multiple filtration layers 214 as shown in FIG. 3C as filtration system 200. By way of example, one embodiment of the presentation invention includes at least two filtration layers 214, the union or combination of which constitutes the filtration layer 114. While the multiple filtration layers 214 are shown on each side of stiffening layer 112, it is understood and appreciated that the multiple filtration layers 214 may be arranged in any order with respect to the outer layer 110, the stiffening layer 112, and the inner layer 116. Moreover, each filtration layer 214, in and of itself, may still be comprised of multiple plies. In some embodiments, each of a pair of filtration layers 214 may have a weight of about fifteen grams per square meter (15 gsm) that may additionally provide an overall filtration efficiency that equals or exceeds the filtration efficiency that would be obtained using a single thirty grams per square meter (30 gsm) filter. Similarly, in other embodiments, the combination of two filtration layers 214, each having a weight of about twenty grams per square meter (20 gsm), may additionally provide an overall filtration efficiency that equals or exceeds the filtration efficiency that would be obtained using a single forty grams per square meter (40 gsm) filter, and so forth for higher desired filtration efficiencies. In another embodiment, as depicted in FIG. 3C, the two or more filtration layers 214 that in combination constitute filtration layer 114, may instead be on opposite sides of, but adjacent to, the stiffening layer 112. In another embodiment, instead of being separated by the stiffening layer 112, the two or more filtration layers 214 may be separated by yet another additional layer, which may also be made from another polymeric material.

In one embodiment, the filtration layer 114 may be capable of maintaining a desired level of high filtration efficiency even when in a saturated state of particulate matter such as during the previously described so-called ‘loading test’ with NaCl aerosol according to NIOSH 42 CFR 84 subpart K and NIOSH Procedure No. TEB-APR-STP-0059. The standard method for assessing performance of filtration efficiency in a saturated state. i.e., during a loading test, is typically run on a TSI 8130A machine or similar equipment. By way of example, the “saturated state” according to NIOSH Procedure No. TEB-APR-STP-0059 means the saturation of a test face covering with sodium chloride (NaCl) cubic crystals. While the NIOSH loading test is mentioned here, it is appreciated that other types of tests such as, but not limited to, other types of particulate loading or saturation tests, may be used to determine the filtration efficiency. The loading test, as required by NIOSH for its N95/N99 certification process, is a more exacting measure of filtration efficiency than a single time point, low mass deposition, instantaneous (i.e. unsaturated), penetration test on similar test equipment.

The face covering system 100 of the present invention, based on a preferred arrangement of the various components as described herein, may have the ability to maintain a high filtration efficiency level that is equal to or better than that required of one or more testing standards used in the FFR industry, including the aforementioned NIOSH NaCl PFE procedure, for N95/N99 respirator certification. By way of example, the face covering system 100 of the present invention may maintain both a high filtration efficiency (≥95%), whether tested in an unsaturated or saturated state, and a low breathing resistance of six (6) to ten (10) millimeters (mm) of water (H₂O), which is well below the NIOSH guidelines of less than or equal to thirty-five (35) (mm) of H₂O for inhalation resistance, according to NIOSH Procedure No. TEB-APR-STP-0007, and less than or equal to twenty-five (25) mm of H₂O for exhalation resistance, according to NIOSH Procedure No. TEB-APR-STP-0003. Applicant has also conducted some preliminary tests with accredited third party laboratories on at least one embodiment of the face covering system 100 of the present invention, and a test report for filtration efficiency (both saturated and unsaturated) and breathing resistance (both inhalation and exhalation) is incorporated by reference herein in its entirety, as follows: Test Report No. T18036-01-1, Issue 1, “N95 Pre-Certification Testing: NIOSH TEB-APR-STP-0003, NIOSH TEB-APR-STP-0007, and NIOSH TEB-APR-STP-0059” conducted by ICS® Inc. Laboratories at the request of BreezLyte LLC (Report dated: 19 May 2023).

In other embodiments, the filtration layer 114 is made from a meltblown polypropylene material chosen to have a high filtration efficiency against particulate matter, aerosols, bacterial particles, and viral particles. Additionally or alternatively, the filtration layer 114 may advantageously operate to provide a low breathing resistance for both inhalation and exhalation (i.e., high breathability). In yet another embodiment, the filtration layer 114 is made from a meltblown material that is composed of a different polymer than polypropylene, such as, but not limited to, polyethylene, nylon, polycarbonate, polystyrene, poly (4-methyl pentene-1), or polybutylene terephthalate. In yet another embodiment, the chosen meltblown polymer used as filtration layer 114 is selected in order for face covering system 100 to maintain its performance in terms of high filtration efficiency (and high breathability) when stored or conditioned at freezing temperatures for a desired time duration, as per the FFP I/II/III standards for certification of FFRs in Europe. In yet another embodiment, filtration layer 114 is a nanofiber material with chosen physical characteristics to support a high filtration efficiency and low breathing resistance, including across a desired range of different temperatures and relative humidities. In yet another embodiment, filtration layer 114 is a nanofiber material, such as, but not limited to, nylon or polyvinylidene (di)-fluoride (PVDF).

In one embodiment, the stiffening layer 112 cooperates with the four (4) panel configuration, consisting of the four (4) layers, including stiffening layer 112, and the associated welds located on or between the four (4) panels (to be discussed below) to help provide structural integrity by shaping and maintaining a sufficiently sized and comfortable breathing space for the wearer's comfort and maintaining breathability by keeping at least some or all of the face covering system 100 materials off or away from the mouth and nostrils of the wearer during normal use. In another embodiment, the stiffening layer 112 provides further protection to one or more face covering system 100 components, including, but not limited to, the filtration layer 114, and may help to keep such components, including the filtration layer 114, as dry as possible. In another embodiment, instead of applying hydrophobic or hydrophilic coatings to the outer layers 110, these types of coatings may instead be applied to the stiffening layer 112 or any other layer, if desired. In another embodiment of the present invention, the stiffening layer 112 may take on different shapes and properties. By way of example and according to at least one embodiment, the stiffening layer 112 is approximately half the width of the other layers, such that it only spans the top central and bottom central panels 156, 158 of the face covering system 100. It is for this reason that FIG. 3A does not depict stiffening layer 112 as FIG. 3A shows an exploded side view of a portion of the face covering system 100 that does not include the top and bottom central panels 156 and 158 for the current embodiment of the present invention. In another embodiment, the stiffening layer 112 is the same width as the other layers, and thus spans all four (4) panels of the face covering system 100.

In one embodiment, the outer layer 110 may also provide a measure of protection of one or more face covering system 100 components such as, but not limited to, the filtration layer 114, wherein such protection may be from various minor mechanical stresses, including, but not limited to, shear forces, tearing forces, abrasion, or possible puncture encountered during the course of donning, doffing, or wearing of face covering 102. In another embodiment, the protection provided by outer layer 110 may merely involve keeping one or more of the other face covering system 100 components as dry as possible. In many embodiments, the outer layer 110 also provides structural support to the four (4)-panel configuration. In at least some embodiments, the outer layer 110 may be made from a material other than the spunbond or nonwoven polypropylene material previously mentioned. In other embodiments, the outer layer 110 may also be coated with a hydrophobic substance to make the face covering system 100 certifiably resistant to penetration by blood (or synthetic blood) or water. In yet another embodiment, a hydrophilic coating is applied to the outer layer 110 to make the face covering system 100 certifiably resistant to penetration by oil.

The inner layer 116 may also provide a measure of protection of the face covering system 100 components such as, but not limited to, the filtration layer 114, wherein such protection may, like as discussed with regards to the outer layer 110, be from various minor mechanical stresses, including, but not limited to, shear forces, tearing forces, abrasion, or possible puncture encountered during the course of donning, doffing, or wearing of face covering 102. By way of example, the inner layer 116 may provide a barrier to fluids, e.g., mucus or saliva, from the wearer's mouth and nose to keep the filtration layer 114 as dry as possible. In one preferred embodiment, the inner layer 116 is made from a polyester staple fiber with a smooth surface to prevent or at least mitigate skin irritation and make the face covering system 100 more comfortable for the wearer. However, it is understood and appreciated that other materials may be used in place of polyester staple fiber to provide both protection of the filtration layer 114 and to be comfortable for the wearer. By way of example, the inner layer 116 may be made from a material other than the polyester staple fiber material previously mentioned. Similar to one or more of the other layers, the inner layer 116 may also be coated with a substance to make it more resistant to penetration by bodily fluids or other liquids as a means of protecting and keeping the filtration layer 114 as dry as possible. In some embodiments, the material of the inner layer 116 is also selected in accordance with satisfying the biocompatibility guidelines of ISO 10993-1-2018 and FDA guidance for biomedical devices that make direct contact with intact skin, including biocompatibility testing for cytotoxicity, skin sensitization, and skin irritation. In other embodiments, the materials used for all four layers of the face covering 102, as well as the two headbands 106, 108, are selected in accordance with satisfying the aforementioned biocompatibility testing FDA guidelines.

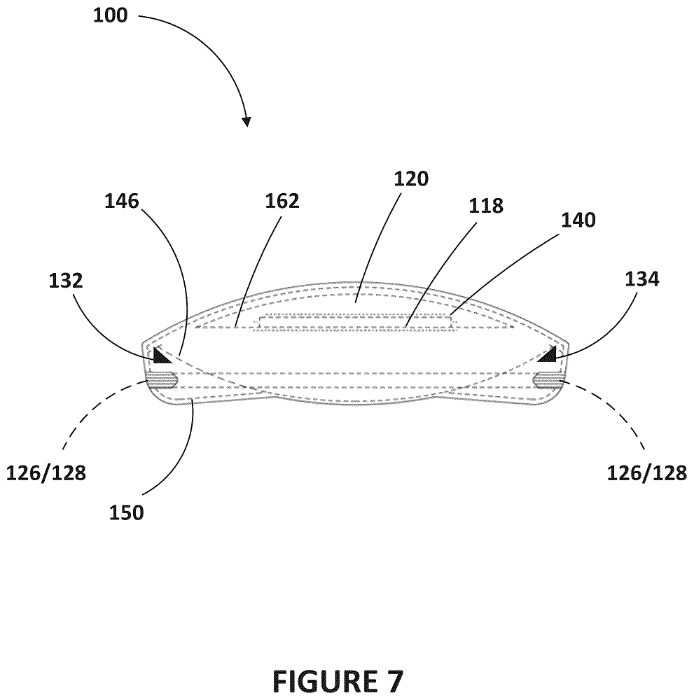

Now referring to FIGS. 5, 5A, 6 and 7, the face covering 102 includes at least two headband welds 126 (upper), 128 (lower) that secure the upper and lower headbands 106, 108, respectively, to the face covering 102. For purposes of clarity, the headband welds 126, 128 are only physically viewable when looking toward the inside of the face covering 102, thus being directly visible by the wearer when donning or doffing the face covering system 100. Thus, FIGS. 5 and 7 show the headband welds 126, 128 in transparency or “hidden”, while FIG. 6 shows them from the inside where the horizontal ridge pattern can be directly observed. Headband welds 126, 128 are also directly visible in FIG. 5A, a cross-sectional view of the face covering system 100, on the interior side of the upper and lower corner flaps 160 but on the far side of face covering 102, past the bisectional cut 5B presented in FIG. 5.

Optionally, the face covering system 100 may include a branding region on the outer layer 110, or even the inner layer 116, (the branding region does not have a reference numeral because it could be placed anywhere), which is typically a region on the exterior of face covering 102 for printed matter such as, but not limited to, trademark or tradename, regulatory codes, lot number, serial number, etc. In a preferred embodiment, the headbands 106, 108 are ultrasonically welded and secured to or with at least the outer layer 110 and likely secured (i.e., ultrasonically welded) to or with some or all other layers as well as headband welds 126, 128.

In at least some embodiments of the present invention, the headband welds 126, 128 penetrate more than just the contact layer of material (i.e., outer layer 110), meaning that additional layers along with the free ends of the headbands 106, 108 are ultrasonically melted and fused (i.e., welded) together as part of the ultrasonic welding process, including some or all of the other three layers (stiffening layer 112, filtration layer 114, and inner layer 116). In some embodiments, the total number of layers involved in the headband welds 126, 128 may be more than four, as they may involve some or all of the layers of more than one panel or maybe as a result of folding various layers. Referring to FIG. 5B, a preferred embodiment of the present invention includes the headband welds 126, 128 secured to the headbands 106, 108 via ultrasonic welding that penetrates through all seven (7) folded layers (from inside to outside: 110, 114, 116, 116, 114, 112, 110) that make up each of the four (4) corner flaps 160 in FIG. 5. In some embodiments, the folding of the layers at each of the four (4) corner flaps 160 (both sides, top and bottom), is performed to ensure that the contact layer is the outer layer 110 but to also ensure the headband welds 126, 128 are on the inside of the face covering 102 (relative to wearer) when donned, doffed, or worn by the wearer. In other embodiments, it may be desired to apply the headband welds 126, 128 to the inner layer 116 as the contact layer. In yet other embodiments, it may be desired to apply the headband welds 126, 128 to the outer layer 110 as the contact layer, but to ensure that the headband welds are located on the outside of the face covering 102 (relative to wearer) when donned, doffed, or worn by the wearer. In yet other embodiments, other folding schemes may be implemented in order to ensure the desired contact layer (from the available layers) for the headband welds 126, 128 and their desired location on face covering 102.

In the illustrated embodiment, the headband welds 126, 128 have a striped or ridged ultrasonic welding pattern that is oriented in a longitudinal or horizontal direction relative to the displayed figures as they appear on the page. In FIGS. 5 and 7, this striped or ridged welding patterns is depicted for headband welds 126, 128 as transparencies, as the headband welds face towards the inside of face covering 102 when donned by the wearer, and hard to see by virtue of multiple intervening layers of (nearly) opaque material. Such a horizontal orientation has been found to improve the overall strength and durability of the headband welds 126, 128 as compared to other orientations. By way of example, the striped or ridged headband welds 126, 128 improve the structural strength of the component attachment region, and they are oriented along force vectors that are parallel with the upper and lower elastic bands, which may be viewed as two-force tension-only members from a structural standpoint. Because the force or tension from the headbands 106, 108 is aligned or at least mostly aligned with the configuration of the headband welds 126, 128, the overall weld strength of each welded portion 126, 128 is improved with the benefit of not having to add additional materials (e.g., adding more weight to the face covering system 100). For some added clarity, the striped or ridged ultrasonic welding pattern aids in the fidelity and durability of the TPE headband material to other polymers such as polypropylene or polyester or polyester staple fiber. In some embodiments, the direct, high strength welding of the TPE headband material over a small welding area, allows for a sufficiently long length of headbands 106, 108 with high elongation capacity, such as the TPE headband material of headbands 106, 108 may stretch to accommodate virtually all human adult (male or female) head sizes during donning, doffing and wearing of face covering system 100 with less facial pressure exerted on the wearer. In other embodiments, the headband welds 126, 128 may feature transverse or vertical ridges perpendicular to the horizontal direction relative to the displayed figures as they appear on the page, though experience shows that when the ridges are oriented in the vertical direction then the headband welds 126, 128 (i.e., the likely point of failure between the headband attachment system 104 and the face covering 102) to be less durable when force or strain is applied to the headband attachment system 104. In yet other embodiments, the headband welds 126, 128 are patterned as a two-dimensional array of dots over the welded surface area, though experience shows these headband weld patterns are also less durable as compared to the horizontally oriented ridges of the preferred embodiment of the present invention.

In addition to the striped or ridged ultrasonic welding pattern and the efficiency of the ultrasonic technique in general, the width and length of the headband welds 126, 128 may also contribute to their strength capabilities. By way of example, a welded portion that is wider than another similar welded portion may be structurally stronger because the applied force or stress to the welded portion is distributed over a larger (i.e., greater width and/or length) area. However, other considerations may also impact the choice of dimensions of the headband welds 126, 128, such as the width or thickness of the headband material of headbands 106, 108 and their resultant elongation capacity or stretchability. In yet other embodiments, one or both of headband welds 126, 128 may be accomplished but by other means of fastening the headbands 106, 108 to the face covering 102, including, but not limited to, sewing with thread or stitches, staples, or glue or other adhesive, or a combination thereof.

Now briefly referring back to FIGS. 3A and 3B, these figures further show a nose wire 118 and a nose cushion member 120. FIG. 5A also shows portions of the nose wire 118 and the nose cushion member 120, respectively, via cross-sections. By way of example, the nose wire 118 may be located between the outer layer 110 and the filtration layer 114. In most embodiments, the nose wire 118 is made from a metallic material such as, but not limited to, steel or aluminum. However, it is appreciated that the nose wire 118 may be made from other materials such as, but not limited to, plastic or some form of a malleable composite fiber-resin material. In most embodiments, the nose wire 118 may have specified and even customizable dimensions for thickness, width, and length with desired properties of malleability to aid in sealing an upper nose panel 152 tightly, snugly, and securely around the wearer's nose. In the current embodiment, the nose wire 118 is embedded between the outer layer 110 and the filtration layer 114 such that the nose wire 118 is positioned into a closely sized pocket formed by a nose wire position control weld seam 140 (this seam is introduced and described below when discussing FIGS. 5, 7) that surround the outer perimeter of the nose wire 118. The welded pocket holding the nose wire 118 helps to keep the nose wire 118 from sliding or moving around in an undesired manner when worn or during donning or doffing steps.

In the illustrated embodiment of FIGS. 3A and 3B, the nose cushion member 120 is located adjacent to the inner layer 116 with a length that is equal to or greater than the length of the nose wire 118. The nose cushion member 120 member is also exposed to the ambient air when the face covering system 100 is in the unfolded or donning position. In one embodiment, the nose cushion member 120 is made from a foam material that feels soft and has a low friction coefficient relative to the wearer's skin surface such that the wearer would expect little to no skin irritation. In one embodiment, the nose cushion member 120 is made from a low-density polyethylene (LDPE) material. In another embodiment of the present invention, the nose cushion member 120 is made from an open celled foam material or a closed cell foam material. In yet another embodiment of the present invention, the nose cushion member 120 is made from a spray on foam material. In an embodiment of the present invention, the nose cushion member 120 is located on the inside top portion of the upper nose panel 152 and it adheres to the inner layer 116. More specifically, the nose cushion member 120 is configured to have its top edge conform to the top curved edge of upper nose panel 152, while its bottom edge forms a straight line, parallel or almost parallel to the nose wire 118 and ending precisely at or slightly above the bottom portion of the nose wire position control weld seam 140 that surrounds the nose wire 118 (FIGS. 5, 7). In another embodiment and by way of example, the nose cushion member 120 may take the form of a triangular shaped component with a rounded top. In yet another embodiment, nose cushion member 110 may be rectangular in shape and aligned parallel to nose wire 118, but instead affixed on the interior side of the upper nose panel 152. While a foam material is considered to work best for the nose cushion member 120, it is appreciated that the nose cushion member 120 may be made from different materials and/or be applied, in the manufacturing sense, to the inside of the face covering system 100 in various ways. In one embodiment, this may be through the use of an adhesive on the back of the foam material of nose cushion member 120, adhering to the inner layer 116 of the upper nose panel 152 with the adhesive facing away from the wearer's nose. In addition, the stiffness and other physical properties of the nose cushion member 120 may be selected to improve comfort for the wearer and sealability of the face covering system 100 to the wearer's facial type and head size. In some embodiments, the material of the nose cushion member 120 is also selected in accordance with satisfying the biocompatibility guidelines of ISO 10993-1-2018 and FDA guidance for biomedical devices that make direct contact with intact skin, including biocompatibility testing for cytotoxicity, skin sensitization, and skin irritation.

Referring now to FIGS. 5, 5A, 5B, 6, and 7, the face covering system 100 includes a variety of “other” ultrasonic welds or seams, in addition to the headband welds 126, 128 described above, and the “other” welds or weld seams are described herein. In one embodiment, the additional ultrasonic welded regions may visually look like seams or stitches, thus the “other” ultrasonic welds described herein may be referred to as “welded seams.” Referring briefly to FIG. 5, the face covering system 100 includes an equatorial weld seam 130 (hereinafter the “EQ weld seam”) that terminates at the right and left sides of face covering 102 and is supplemented with right and left right equatorial support welds 132, 134, respectively (hereinafter referred to as the right and left EQ support welds) that are slightly offset from the equator.

Briefly referring back to the headband attachment system 104, the ultrasonic welding of the headband attachment system 104 to the face covering 102 fuses the TPE headband material with at least the polypropylene outer layer 110. In at least one embodiment of the present invention and referring specifically to FIG. 5B, the headband welds 126, 128 may be produced by ultrasonically welding the headband materials to at least some or all of the layers 110, 112, 114, and 116 that constitute some or all of the panels 152, 154, 156, and 158. In some embodiments, two adjacent panels may overlap as shown in FIG. 5B because for each welded portion 126, 128, the ultrasonic welding processes may sufficiently penetrate through all of the aforementioned layers and panels to fuse the various components of the face covering system 100 together. In the preferred embodiment of the present invention, the two adjacent panels involved in the ultrasonic welding of headband 106 via welded portion 126 are the upper nose panel 152 and a top central panel 156, while the two adjacent panels involved in the ultrasonic welding of headband 108 via welded portion 128 are a bottom chin panel 154 and a bottom central panel 158,

The EQ weld seam 130 extends longitudinally (e.g., horizontally when viewing FIG. 5) and structurally couples the upper half 136 of the face covering system 100 to the lower half 138 of the face covering system 100. The EQ weld seam 130 and the “other” welded seams (described hereafter) may be made using an ultrasonic welding technique, which is a thermal welding technique in which enough heat via high frequency acoustic vibrations may be applied to particular sections or portions of the face covering system 100 to weld, melt, bond, fuse, or otherwise attach at least some of the face covering system 100 components to other components of the face covering system 100. In some embodiments, at least two components are fused together (e.g., two layers or two panels) via ultrasonic welding, but in many embodiments more than two components may be fused via ultrasonic welding (e.g., 3, 4, 5, 6, 7, 8 or even more layers or panels) may be fused together.

In at least one embodiment, the EQ weld seam 130 operates as the primary central weld that penetrates all four (4) layers, 110, 112, 114, and 116, respectively, across both of the central two (2) panels 156, 158 (see FIG. 6), meaning that a total of eight (8) layers are welded/fused together along the EQ weld seam 130 (see the “stacked” layers in FIG. 5B shown within the dashed-line circle or ellipse). In some embodiments, the EQ weld seam 130 provides key structural support that permits the panels 152, 154, 156, and 158 to form the breathing space (FIG. 6) in addition to providing the structural support that helps maintain the shape of the face covering system 100 when in the donned or worn position. Accordingly, the strength, penetration depth of the welds, and the configuration of the EQ weld seam 130 may advantageously improve the breathability and comfort, while also operating as one of the primary structural components that help keep the top and bottom central panels 156, 158, (FIG. 6) respectively, away from the mouth and lips of the wearer during normal use. Similarly, in the preferred embodiment of the present invention, the right and left, slightly offset, EQ support welds 132, 134 operate to penetrate, and thus fuse, all four (4) layers, 110, 112, 114, and 116, respectively, across both of the central two (2) panels 156, 158 (see FIG. 6), meaning that a total of eight (8) layers are welded/fused together by EQ support welds 132, 134. In some embodiments, the EQ support welds 132, 134 are used to improve the durability of the face covering system 100 by making it more resistant to tearing or pulling forces (i.e., shear and tensile forces) applied along the EQ weld seam 130 at either side. In other embodiments, the EQ support welds 132, 134 are also used to structurally reinforce the face covering 102 so as to further ensure that the top and bottom central panels 156, 158, (FIG. 6) respectively, stay sufficiently away from the mouth and lips of the wearer during normal use, thereby reinforcing or support the breathing space (FIG. 6) provided by face covering system 100.

Now referring to FIGS. 5 (primarily focused on FIG. 5), 6, and 7, the remaining “other” welds and/or weld seams are now described. The remaining “other” welds and weld seams of face covering system 100, according to at least one embodiment of the present invention, include the nose wire position control weld seam 140, an upper nose panel arc weld seam 142, a bottom chin panel arc weld seam 144, a top central panel weld seam 146, and a bottom central panel weld seam 148. The face covering system 100 also includes an outer wing weld seam 150 that forms an edge portion or perimeter portion for the combination of the top central panel 156 and the bottom central panel 158. In addition, the top central weld seam 146, which looks like a sideways or horizontally placed football, and the outer wing weld seam 150 cooperates to form four (4) corner flaps 160 (best seen in FIG. 5), in which two of the corner flaps 160 are located on both sides of the top central panel 156 and the other two corner flaps 160 are located on both sides of the bottom central panel 158.

The nose wire position control weld seam 140 operates to form a pocket or enclosure to closely receive and secure the nose wire 118, which helps prevent the nose wire 118 from moving or shifting relative to the upper nose panel 156 during the donning, doffing or wearing of face covering 102. In one embodiment, the nose wire position control weld seam 140 cooperates with the upper nose panel arc weld seam 142 to provide additional structural and position control for the face covering system 100. In other embodiments, the shape of the nose wire position control weld seam 140 may take a variety of forms such as, but not limited to, a rectangle, a partial rectangle, rhombus, trapezoid, circle, ellipse or some other shape that complements the shape of the nose wire 118 and fully encloses the nose wire 118. Accordingly the nose wire position control weld seam 140 permits the wearer to customize the shape of the nose wire 118 to closely conform to the bridge of the wearer's nose, thus preventing the nose wire 118 from moving or shifting so much that the wearer continually re-adjusts the shape and fit of the nose wire 118 while the face covering system 100 is being worn. In the preferred embodiment of the present invention, the nose wire position control weld seam 140 is in composed of two weld lines of slightly different length, running parallel to and slightly above and below the nose wire 118 and also with two individual weld imprints that are horizontally aligned and located adjacent to the left and right ends of the nose wire (see FIG. 7). In some embodiments, the nose wire position control weld seam 140 penetrates and fuses all three (3) layers of upper nose panel 152. For reference, the bottom edge of nose cushion member 120 is represented as the dashed line 162 in FIG. 5 as the nose cushion member is attached on the inside of the upper nose panel 152 and not visible from the front.

Regarding the upper nose panel arc weld seam 142, it operates to provide the strength, shape, and at least some sealing capability for the upper nose panel 152. In some embodiments, the upper nose panel arc weld seam 142 penetrates and fuses all three (3) layers of upper nose panel 152. Likewise, the bottom chin panel arc weld seam 144 operates to provide the strength, shape, and at least some sealing capability for the bottom chin panel 154. In some embodiments, the bottom chin panel arc weld seam 144 penetrates and fuses all three (3) layers of the bottom chin panel 154. In the preferred embodiment of the present invention, the top central panel weld seam 146 operates to provide strength and shape for the top central panel 156 and it couples at least a portion of the upper nose panel 152 to the top central panel 156. In some embodiments, the top central panel weld seam 146 penetrates and fuses all four (4) layers of top central panel 156 and all three (3) layers of the upper nose panel 152. Likewise, the bottom central panel weld seam 148 operates to provide strength, shape, and some sealing capability for the bottom central panel 158 and it couples a portion of the bottom chin panel 154 to the bottom central panel 158. In some embodiments, the bottom central panel weld seam 148 penetrates and fuses all four (4) layers of bottom central panel 158 and all three (3) layers of the bottom chin panel 154. In other embodiments, some or all of the upper nose panel arc weld seam 142, the bottom chin panel arc weld seam 144, the top central panel weld seam 146, and the bottom central panel weld seam 148 may penetrate only a subset of the layers that make up the panel or the panels to be joined or folded.

Lastly with respect to the “other” welds, the face covering system 100 includes the outer wing weld seam 150 located on the edge or perimeter of each of the four corner flaps 160 two adjacent to the top central panel 156 and two adjacent to the bottom central panel 158 (FIG. 5A). In some embodiments, outer wing weld seam 150 in combination with the four corner flaps 160 provides at least one of the means for coupling or attaching the four (4)-panel configuration (FIG. 6) to other components of the face covering system 100, including the headbands 106 and 108, wherein the headband welds 126, 128 on both the left and right sides are located on the inside of their respective corner flaps 160. In some embodiments, outer wing weld seam 150 also provides structural integrity for the top central panel 156 and the bottom central panel 158 by joining a portion of each to the upper nose panel 152 and the bottom chin panel 154, respectively. In the preferred embodiment of the present invention, top central panel 156 is joined to upper nose panel 152 by a combination of the outer wing weld seam 150 on both the top left and top right side and by the top central panel weld seam 146 in the center. Similarly, in the preferred embodiment of the present invention, bottom central panel 158 is joined to bottom chin panel 154 by a combination of the outer wing weld seam 150 on both the bottom left and bottom right side and by the bottom central panel weld seam 148 in the center. In the preferred embodiment of the present invention, outer wing weld seam 150 penetrates seven (7) layers, four (4) from either the top or bottom central panel (156, 158) and three (3) from either the adjacent upper nose panel 152 or the adjacent bottom chin panel 154, respectively. As discussed above in regard to upper nose panel arc weld seam 142, the bottom chin panel arc weld seam 144, the top central panel weld seam 146, and the bottom central panel weld seam 148, the outer wing weld seam 150 may penetrate only a subset of the layers that make up the panel or the panels to be joined or folded.

FIG. 6 shows the face covering system 100 from the perspective of the person about to don the face covering system 100 (i.e., the unfolded or donning configuration). The face covering system 100 of the illustrated embodiment shows an unfolded four (4)-panel configuration. The four panels include the upper nose panel 152 to generally cover the nose area of a wearer's face, a bottom chin panel 154 to generally cover the chin area of the wearer's face, a top central panel 156 to cover the upper mouth portion of the wearer's face, and a bottom central panel 158 to cover the lower mouth portion of the wearer's face. In at least one embodiment, the upper nose and bottom chin panels 152, 154, are moveable and conformable to the face of the wearer while cooperating with the top and bottom central panels 156, 158, to provide a comfortable breathing space, such that “breathing space” 164 (FIG. 6) generally identifies the region just underneath the overhang of the wearer's nose combined with the region in front of the mouth and lips of the wearer where ambient air is exchanged in and out of the wearer's respiratory system via their mouth or nose.

The unfolded four (4)-panel configuration, consisting of panels 152, 154, 156, and 158, in concert with the various welded seams, may advantageously provide the wearer with improved comfort and improved sealability due to the way the panels are able to move and shift relative to one another when being placed on the wearer in the open, unfolded configuration. In one aspect, the increased comfort is achieved because the four (4)-panel configuration helps to keep the two central panels 156, 158 from rubbing against the lips, mouth, or nostrils of the wearer when the wearer is communicating, breathing, or doing other tasks that may cause the standard surgical mask 14 to lose sealability or flatten against the wearer's face or mouth. In addition, the four (4)-panel configuration, due to the panels being moveable, shiftable, or otherwise cooperate relative to each other, may allow the face covering system 100 to provide improved sealability and improved comfort across a wide assortment of different adult head sizes and facial types characterized by a wide range of different facial dimensions. Applicant has also conducted some preliminary tests with accredited third party laboratories on at least one embodiment of the face covering system 100 of the present invention, and a test report for the sealability (i.e., a respirator “seal fit test”) is incorporated by reference herein in its entirety, as follows: Test Report No. T17899-01-1, Issue 1, entitled “Abbreviated Testing to: ASTMF3407-21 Standard Test Method for Respirator Fit Capability for Negative-Pressure Haff-Facepiece Particulate Respirators” conducted by ICS® Inc. Laboratories at the request of BreezLyte LLC (Report dated: 15 Mar. 2023). An additional test report for the sealability is also incorporated by reference herein in its entirety, as follows: Test Report No. 105680034CRT-001, Intertek Project No. G105680034, Version: 28 Nov. 2018, entitled “BreezLyte, LLC Test Report” conducted by Intertek Group plc (a public limited company registered in England and Wales) at the request of BreezLyte, LLC (Report dated: 24 Jan. 2024). Furthermore, when combining the moveable, conformable four (4)-panel configuration with the headband attachment system 104 (described above), this combination may allow the face covering system 100 to approximate a “universal” or a “one-size-fits-all” type of a fit with improved sealability and improved comfort without undesired, possibly uncomfortable, pressure points on the wearer's face or head.

FIG. 7 shows the face covering system 100 in a folded or closed configuration as observed from above, with the top central panel 156 (and two corner flaps 160) exposed to the viewer. This folded configuration is made possible because of the four (4)-panel configuration, in cooperation with the various welded seams, both of which have been previously described above. Some of the welded seams are shown in FIG. 7 to add clarity. These include EQ weld seam 130, EQ support welds 132, 134, nose wire position control weld seam 140, top central panel weld seam 146, outer wing weld seam 150 (on both sides), which all may be directly visible on the exterior of face covering system 100 when in the folded configuration of FIG. 7. Headband welds 126, 128 (upper and lower headband welds) may not be directly visible or at least they may be obscured due to intervening layers of material. The headband welds 126, 128, nose cushion member 120 (along with its bottom edge 162), and nose wire 118, are also shown in FIG. 7 but again they are shown in transparency or hidden line format because they are not directly visible when observing the face covering system 100, in the folded configuration, from above. The folded configuration may advantageously allow the wearer to easily place the folded face covering system 100 into pockets or handbags, making them convenient to store and highly portable. And this configuration may further provide the benefit of compact packaging for shipping purposes and inventory purposes. In one embodiment, the face covering systems 100 may be individually wrapped in the folded configuration for shipping and sterility or cleanliness purposes. In the current embodiment of the present invention, the face covering system 100 may be refolded back to the flat, folded configuration, including tucking the two headbands 104, 108 back inside of the face covering 102, after donning or wearing for easy storage before re-use. In some embodiments, the face covering system 100 may come off the manufacturing assembly line in the folded configuration and packaged. When the wearer wants to use a new face covering system 100, the wearer may have to manually separate the two folded halves of the face covering system 100 to make it expand into the donning or wearable configuration as shown in FIG. 6.

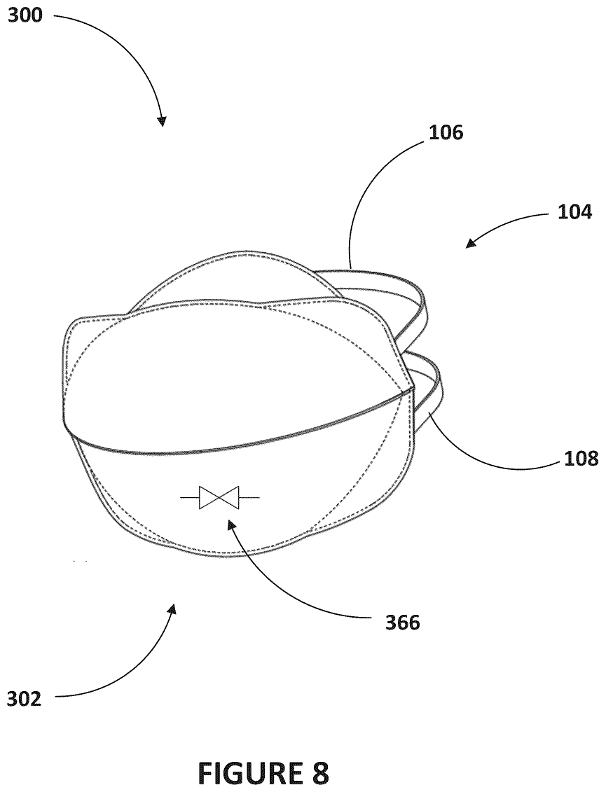

Lastly, FIG. 8 shows a face covering system 300 having a face covering 302 that includes a valve or valve-type device 366, and the headband system 104 with headbands 106, 108, respectively. The headband attachment system 104, for purposes of the present embodiment, is the same as at least one of the headband attachment systems described above. Similarly, the face covering 302 may be substantially similar to the face covering 102, described above, (e.g., similar layers, similar panels, similar welds, etc.) except for the areas around the new valve-type device 366 would require at least some modification. The valve-type device 366 is schematically illustrated as a standard GATE valve for brevity and ease of understanding. The valve-type device 366 may take a variety of forms other than just a GATE valve, for example the valve-type device 366 may be a pressure valve, release or relief valve, control valve, isolating valve, ball valve, diaphragm valve, butterfly valve, or any other type of valve that may provide a means of communicating a fluid (e.g., the fluid is ambient air) to and from the respiratory tract of the wearer and the ambient environment. Finally, the valve-type device 366 may be located anywhere within, among, or on the face covering system 300, for example the valve-type device 366 may be positioned on the outer layer of the face covering 302 and also offset relative to a nose centerline of the wearer.

The face covering system 100 of the present invention provides a breathing space that is comfortable, in that it is both sufficiently sized for a wide variety of wearers across different facial types and face/head dimensions and is robust to typical wearer head movements and facial actions, while maintaining sealability and without excessive, often uncomfortable, facial pressure due to low stretchability headbands. Another benefit of a sufficiently sized and robust breathing space besides wearer comfort is reducing the likelihood of wearer mucosa, saliva, or nasal drip from coming into contact with the inner surface of the face covering system 100, thus preserving comfort without compromising filtration.

In the preferred embodiment of the present invention, the choice of different materials in concert with the four (4)-panel configuration and the various welds used to create a desired unfolded, open configuration for donning and wearing of face covering system 100, including headband attachment system 104, allow the face covering system 100 to not only comply with NIOSH N95 standards, but also ASTM F2100 standards, thereby allowing for potential use as a surgical N95 respirator in hospital or healthcare settings. In other embodiments, face covering system 100 may be used in healthcare applications to filter bacterial or viral particles and other disease-related particulate matter from entering the respiratory tract of the wearer. In other embodiments, face covering system 100 may be used in industrial applications to filter dust and other industrial particulate matter from entering the respiratory tract of the wearer. In yet other embodiments, face covering system 100 may be used in consumer applications to filter dust, pollen, pollutants, and other environmental particulate matter from entering the respiratory tract of the wearer. In other embodiments, face covering system 100 may be used in public health applications to filter infectious viral particles (e.g. COVID-19) from entering the respiratory tract of the wearer, including essential workers, healthcare workers, and public consumers during a pandemic or other respiratory health crisis.

As one of skill in the art will appreciate, the many varying features and configurations described above in relation to the several exemplary embodiments may be further selectively applied to form the other possible embodiments of the present invention. For the sake of brevity and considering the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A face covering system for protecting a wearer from airborne particulate matter, the face covering system comprising:
a head attachment system; and
a face covering having a plurality of layers including an outer layer, a filtration layer, and an inner layer, the face covering further providing a breathing space when in the unfolded or donning position, wherein the breathing space is enclosed by an upper nose panel to generally cover the nose area of a wearer's face, a bottom chin panel to generally cover the chin area of the face, a top central panel to cover the upper mouth portion of the face, and a bottom central panel to cover the lower mouth portion of the face, wherein the upper nose and bottom chin panels are moveable and conformable to the face while cooperating with the top and bottom central panels, wherein the top and bottom central panels are sufficiently flexible for cooperating with the upper nose and bottom chin panels to provide the breathing space,
the face covering, furthering including:
a nose cushion member made from a foam material;
a nose wire located between two of the plurality of layers of the face covering; and
at least two headband welds for attaching the head attachment system to the face covering.

2. The system of claim 1, wherein the head attachment system includes an upper elastic band and a lower elastic band, and wherein the free ends of each band are attached to the face covering to form the headband welds.

3. The system of claim 2, wherein the upper and lower elastic bands are made from the same material.

4. The system of claim 2, wherein at least one of the elastic bands is made from a thermoplastic elastomer (TPE) material.

5. The system of claim 2, wherein the upper elastic band includes an upper elastic band elongation capacity, the lower elastic band includes a lower elastic band elongation capacity, and the upper elastic band elongation capacity is greater than or equal to the lower elastic band elongation capacity.

6. The system of claim 5, wherein at least one of the elastic band elongation capacities is about three hundred and fifty percent (350%) or greater.

7. The system of claim 1, wherein the nose cushion member is located on the inner layer adjacent to the nose wire.

8. The system of claim 1, wherein the nose cushion member is exposed to the ambient air when the face covering is unfolded.

9. The system of claim 1, wherein the face covering includes at least one additional filtration layer, wherein at least one of the filtration layers has a weight of about twenty grams per square meter (20 gsm) or greater.

10. The system of claim 1, wherein the face covering further includes a stiffening layer.

11. The system of claim 10, wherein the stiffening layer of the face covering is located between the outer layer and the filtration layer.

12. The system of claim 1, wherein the inner layer includes the top and bottom central panels and the upper nose and bottom chin panels, wherein the upper nose and bottom chin panels are configurable to conform to the wearer's facial features to provide a seal from particulate matter from the ambient environment when the face covering is worn.

13. The system of claim 1, wherein the upper nose and bottom chin panels are moveable relative to each other and to the top and bottom central panels.

14. The system of claim 1, wherein each layer is made from at least one sheet, and wherein the number of layers comprising each panel are selected and arranged to provide a level of filtration efficiency for the face covering system that equates to or exceeds the level of filtration efficiency that would be obtained using a single filtration layer rated at a filtration efficiency associated with forty grams per square meter (40 gsm) of the same filter material.

15. The system of claim 1, wherein each panel of the face covering is comprised of a plurality of layers made from a plastic or synthetic material.

16. The system of claim 15, wherein the stiffening layer is made from a spunbond fabric material.

17. The system of claim 1, wherein the nose wire is located between the inner layer and the filtration layer.

18. A face covering system for protecting a wearer from airborne particulate matter, the face covering system comprising:
a head attachment system; and
a face covering having a plurality of layers including an outer layer, a filtration layer, and an inner layer, the face covering further having a plurality of panels that form a breathing space when in the unfolded or donning position, wherein the plurality of panels include an upper nose panel, a bottom chin panel, a top central panel, and a bottom central panel,
the face covering, furthering including:
a nose cushion member located on the inner layer adjacent to the nose wire;
a nose wire located between two of the plurality of layers of the face covering;
at least two headband welds for securing an upper and a lower headband of the headband attachment system to the face covering; and
an equatorial weld seam that terminates at the right and left sides of the face covering, wherein the equatorial weld seam extends latitudinally and structurally couples the top and bottom central panels of the face covering system by fusing the plurality of layers comprising the top and bottom central panels.

19. The system of claim 18, wherein the face covering further includes a stiffening layer.

20. The system of claim 18, wherein the face covering further comprises equatorial support welds configured to penetrate and thus fuse the plurality of layers across the top and bottom central panels.

21. The system of claim 20, wherein the equatorial support welds structurally reinforce the face covering system, so the top and bottom central panels remain sufficiently away from the mouth and lips of the wearer during normal use.

22. The system of claim 20, wherein the equatorial support welds operate to help further reinforce the breathing space of the face covering system.

23. The system of claim 18, wherein the face covering system includes a nose wire position control seam, wherein the nose wire position control weld seam forms a pocket or enclosure to closely secure the nose wire to prevent the nose wire from shifting relative to the upper nose panel during donning, doffing, or wearing of the face covering system.

24. The system of claim 18, wherein the face covering system includes an upper nose panel arc weld seam, the upper nose panel arc weld seam operates to provide strength, shape, and at least some sealing capability for the face covering system.

25. The system of claim 18, wherein the face covering system includes a bottom chin panel arc weld seam, the bottom chin panel operates to provide strength, shape, and at least some sealing capability for the face covering system.

26. The system of claim 18, wherein the face covering system includes a top central panel weld seam, the top central panel weld seam couples a portion of the upper nose panel to the top central panel, and the top central weld seam operates to provide strength, shape, and at least some sealing capability for the face covering system.

27. The system of claim 18, wherein the face covering system includes a bottom central panel weld seam, the bottom central panel weld seam couples a portion of the bottom chin panel to the bottom central panel, and the bottom central weld seam operates to provide strength, shape, and some sealing capability for the face covering system.

28. The system of claim 18, wherein the face covering system includes an outer wing weld seam that forms an edge portion or perimeter portion for the top and bottom central panels, and the outer wing weld seam provides structural integrity for the top and bottom central panels joining a portion of each to the upper nose panel and the bottom chin panel.

29. The system of claim 18, wherein the equatorial weld seam operates as the primary weld that penetrates and fuses the plurality of layers of the top and bottom central panels.

30. The system of claim 29, wherein the equatorial weld seam provides structural support for the plurality of panels to form the breathing space and provides structural support that helps maintain the shape of the face covering system when in the donned or worn position.

31. The system of claim 18, wherein the equatorial support welds improve the durability of the face covering system by making the face covering system more resistant to tearing or pulling forces applied along the two sides of the equatorial weld seam at either side of the face covering system.

32. The system of claim 18, wherein the headband welds comprise an ultrasonic weld for thermally bonding the head attachment system to the face covering.

33. The system of claim 18, wherein the headband welds include a striped or ridged pattern.

34. A face covering system for protecting a wearer from airborne particulate matter, the face covering system comprising:
a head attachment system; and
a face covering having a plurality of layers including an outer layer, a filtration layer, and an inner layer, the face covering further having an upper nose panel to generally cover the nose area of a wearer's face, a bottom chin panel to generally cover the chin area of the face, a top central panel to cover the upper mouth portion of the face, and a bottom central panel to cover the lower mouth portion of the face, wherein the number of each of the layers are arranged and configured such that a filtration efficiency of the face covering system does not decrease by more than two percent (2.0%) from its unsaturated state to its saturated state,
the face covering, furthering including:
a nose cushion member located on the inner layer adjacent to the nose wire;
a nose wire located between two of the plurality of layers of the face covering;
at least two headband welds for securing an upper and a lower headband of the headband attachment system to the face covering.

35. The system of claim 34, wherein the number of each of the layers are arranged and configured to provide the face covering system with an inhalation breathing resistance that is less than ten millimeters of water (10 mm H₂O).

36. The system of claim 34, wherein the face covering further includes a stiffening layer.

37. The system of claim 34, wherein the head attachment system includes an upper elastic band and a lower elastic band, and wherein the free ends of each band are attached to the face covering to form at least one of the headband welds.

38. The system of claim 34, wherein the nose wire is located between the inner layer and the filtration layer.

39. The system of claim 34, wherein the nose cushion member is made from a foam material.

40. A face covering system for protecting a wearer from airborne particulate matter, the face covering system comprising:
a head attachment system; and
a face covering having a plurality of layers including an outer layer, a filtration layer, and an inner layer, the face covering further providing a breathing space when in the unfolded or donning position, wherein the breathing space is enclosed by an upper nose panel to generally cover the nose area of a wearer's face, a bottom chin panel to generally cover the chin area of the face, a top central panel to cover the upper mouth portion of the face, and a bottom central panel to cover the lower mouth portion of the face,
the face covering, furthering including:
a nose cushion member located on the inner layer adjacent to the nose wire;
a nose wire located between two of the plurality of layers of the face covering;
at least two headband welds for securing an upper and a lower headband of the headband attachment system to the face covering,
wherein the breathing space enclosed by the four panels provides comfort, sealability, and operates to help keep the upper nose and bottom chin panels from rubbing against the lips of the wearer when the wearer is communicating, breathing, or doing other tasks that may cause movement of the lips of the wearer.

41. The system of claim 40, wherein the face covering further includes a stiffening layer.

42. The system of claim 40, wherein the upper nose and bottom chin panels are moveable and conformable to the face while cooperating with the top and bottom central panels, wherein the top and bottom central panels are sufficiently flexible for cooperating with the upper nose and bottom chin panels to provide the breathing space.

43. The system of claim 40, wherein the face covering system provides an inhalation breathing resistance that is less than ten millimeters of water (10 mm H₂O).

44. The system of claim 40, wherein the face covering system provides a high filtration efficiency that does not decrease by more than two percent (2.0%) from its unsaturated state to its saturated state.

45. The system of claim 44, wherein the filtration layer captures at least ninety-five percent (95%) of the non-oil aerosol particulates that may be inhaled through the face covering system to provide the high filtration efficiency.

46. The system of claim 40, wherein each layer is made from at least one sheet, and wherein the number of layers comprising each panel are selected and arranged to provide a level of filtration efficiency for the face covering system that equates to or exceeds the level of filtration efficiency that would be obtained using a single filtration layer rated at a filtration efficiency of forty grams per square meter (40 gsm) filter.

47. The system of claim 40, wherein the filtration layer captures at least ninety-five percent (95%) of the non-oil aerosol particulates that may be inhaled through the face covering system even when the face covering system is in a saturated state.
